(19) United States
(12) Patent Application Publication
(10) Pub. No.: US 2011/0191192 A1
(43) Pub. Date: Aug. 4, 2011

(54) METHODS APPARATUS AND SYSTEMS FOR FACILITATING THE SALE OF VENTURE RELATED FINANCIAL INSTRUMENTS

(76) Inventor: Johnathan Assia, Savion (IL)

(21) Appl. No.: 13/020,365

(22) Filed: Feb. 3, 2011

Related U.S. Application Data
(60) Provisional application No. 61/300,875, filed on Feb. 3, 2010.

(51) Int. Cl. G06Q 40/00; G06Q 30/00

(52) U.S. Cl. 705/14.73; 705/37

(57) ABSTRACT

Disclosed is a system for facilitating venture financing comprising a communication module adapted to receive over a communication network data representing one or more parameters associated with the venture. A first module of the system may be adapted to initiate one or more database queries using search terms derived from the one or more received parameters and may further be adapted to perform automated business analytics on results from the one or more database queries so as to compile information indicative of an investment potential of the venture. A second module of the system may be adapted to accept, execute and/or record financial transactions related to one or more financial instruments of the venture. One or more modules of the system may be adapted to generate a web banner associated with one or more financial instruments of the venture, such that the banner includes a code indicating the venture and/or a financial instrument of the venture.

### RELATED APPLICATIONS

The present application claims priority from U.S. Provisional Patent Application 61/300,875 filed on 3 Feb. 2010.

### FIELD OF THE INVENTION

The present invention relates generally to the field of financial and analytic computing. More specifically, the present invention relates to computer based methods, apparatus, and systems for facilitating the sale of venture related financial instruments.

### BACKGROUND

Businesses, such as startups seeking to grow, may raise funds by issuing shares. When a business (alternatively referred to as a “company”) offers its shares to the public for the first time, this offer of shares is called the Initial Public Offering (IPO) of the business, and the business is said to “go public”. Often, a promising new business going public will attract the interest of affluent investors such as angels or venture capitalists using the services of an investment bank. A typical transaction is discussed below with reference to FIG. 1a. As illustrated, a business (10) seeks to raise funds by offering shares (12) to the public. To find investors to buy the shares, the business (10) uses the services of an investment bank (14). The investment bank may use its own funds to buy shares, and/or it may look for external investors to buy the shares.

In this scenario, the investment bank (14) locates an external investor (16), who has an interest to buy (18) shares in a business that appears to have good potential to provide big returns on the investment. After the investment bank (14) contacts the investor (16) and describes the investment opportunity, the investor (16) considers whether to purchases shares in the business (10). The investment bank (14) also performs due diligence to determine whether it can provide the investor (16) sufficient assurances that the likelihood of major problems with the proposed transaction is sufficiently low to justify the investment in the business. In this case, the investment bank (14) provides a favorable report, the investor (16) decides to buy the shares, and the investment bank (14) underwrites the transaction. The transaction is complete when the investor (16) receives the shares from the business (10) and the business (10) receives the desired new funds from the investor (16). The investment bank (14) is typically compensated with a commission based on the purchase amount. The business (10) may also compensate the investment bank (14) by issuing it shares in the business (10).

Such a transaction model is not as conducive to a transaction with an investor (20) in FIG. 1b that is significantly less affluent than the investor (16) in FIG. 1a. That is, although the less affluent investor (20) nonetheless has some funds that it wants to invest in the business (10), the funds are not enough to attract the attention of the investment bank (14), which typically will not consider investments valuing less than a preset minimum amount.

Similarly, the transaction model of FIG. 1a is not as conducive to a transaction with a small business (22) in FIG. 1c that appears to the investment bank (14) to be significantly less likely to provide as great a return on investments as the business (10) would provide. That is, although the smaller business (22) seeks to raise funds, the investment bank (14) is less likely to be interested in facilitating investments, for example, by finding interested investors and by underwriting the transaction for it, than it would for the larger business (10).

Accordingly, it would be desirable to have a mechanism in place to enable lesser affluent investors to invest in promising businesses; and it would also be desirable to have a mechanism in place to enable smaller businesses to raise funds.

### SUMMARY

The present invention includes methods, apparatus and systems for facilitating venture related financing and/or sales of venture related financial instruments. According to some embodiments, there is provided a system including a communication module adapted to receive over a communication network data representing one or more parameters associated with the venture. A first module of the system may be adapted to initiate one or more database queries using search terms derived from the one or more received parameters and further adapted to perform automated business analytics on results from the one or more database queries so as to compile information indicative of an investment potential of the venture. A second module of the system may be adapted to electronically accept, execute and/or record financial transactions related to financial instruments of the venture.

The communication module or another communication module may be adapted to communicate some or all of the compiled information to: (1) an affiliate investment bank, and/or to (2) a marketing affiliate. One or more modules of the system may be adapted to (e.g. automatically) generate a web banner associated with one or more financial instruments of the venture. The web banner associated with one or more financial instruments of the venture may include (e.g. embedded) an identifier or code identifying the venture and/or a specific financial instrument. The web banner may be a gif banner, a flash banner, an HTML banner or any other type of banner or widget known today or to be devised in the future.

The web banner associated with one or more financial instruments of the venture may also include a code identifying an affiliate investment bank and/or a marketing affiliate through which the banner is distributed. The marketing affiliate may be a website operator or an online advertising company. According to further embodiments, the system may include one or more modules adapted to record when a transaction is initiated and/or consummated through a banner distributed by a given marketing affiliate. The marketing affiliate may be credited some commission when a transaction initiated through one of their banners is consummated.

The present invention may enable transactions between middle-class investors and small businesses/ventures. The relative ease of operation and the lower overhead costs for investment banks may compensate for smaller individual commissions by enabling a greater number of transactions.

According to some embodiments of the present invention, transactions between businesses/ventures and investors may be arranged by exploiting a common communication network such as the Internet to facilitate communication between the parties. According to some embodiments of the present invention, the use of the networks may lower operating costs to increase profits thereby justifying the involvement with less affluent investors and smaller businesses/ventures. Nonetheless, the invention is not limited to use by only less affluent investors and/or smaller businesses.

Embodiments of the present invention may also provide services that resemble in some respects those of a stock exchange. Further embodiments of the present invention may also provide services analogous to those of a holding company.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1a-1c represent conventional relationships between businesses, investors, and underwriters;

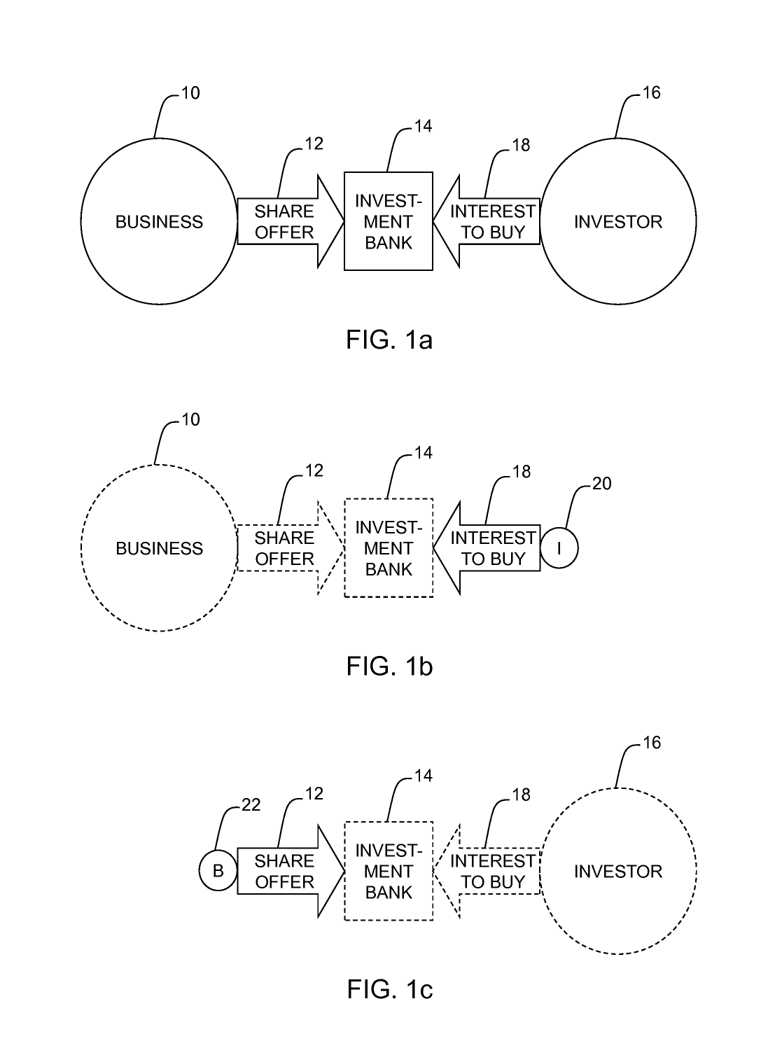

FIG. 2 shows an exemplary illustration of an investment manager facilitating the sale of shares from a business to an investor according to some embodiments of the present invention; and

FIG. 3 shows an exemplary flowchart portraying a process of facilitating the sale of shares from a business to an investor according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes methods, apparatus and systems for facilitating venture related financing and/or sales of venture related financial instruments. According to some embodiments, there is provided a system including a communication module adapted to receive over a communication network data representing one or more parameters associated with the venture. A first module of the system may be adapted to initiate one or more database queries using search terms derived from the one or more received parameters and further adapted to perform automated business analytics on results from the one or more database queries so as to compile information indicative of an investment potential of the venture. A second module of the system may be adapted to accept, execute and/or record financial transactions related to financial instruments of the venture.

The communication module or another communication module may be adapted to communicate some or all of the compiled information to: (1) an affiliate investment bank, and/or to (2) a marketing affiliate. One or more modules of the system may be adapted to generate a web banner associated with one or more financial instruments of the venture. The web banner associated with one or more financial instruments of the venture may include (e.g. embedded) a code identifying the venture and/or a specific financial instrument.

The web banner associated with one or more financial instruments of the venture may also include a code identifying an affiliate investment bank and/or a marketing affiliate through which the banner is distributed. The marketing affiliate may be a website operator or an online advertising company. According to further embodiments, the system may include one or more modules adapted to record when a transaction is initiated and/or consummated through a banner distributed by a given marketing affiliate. The marketing affiliate may be credited some commission when a transaction initiated through one of their banners is consummated.

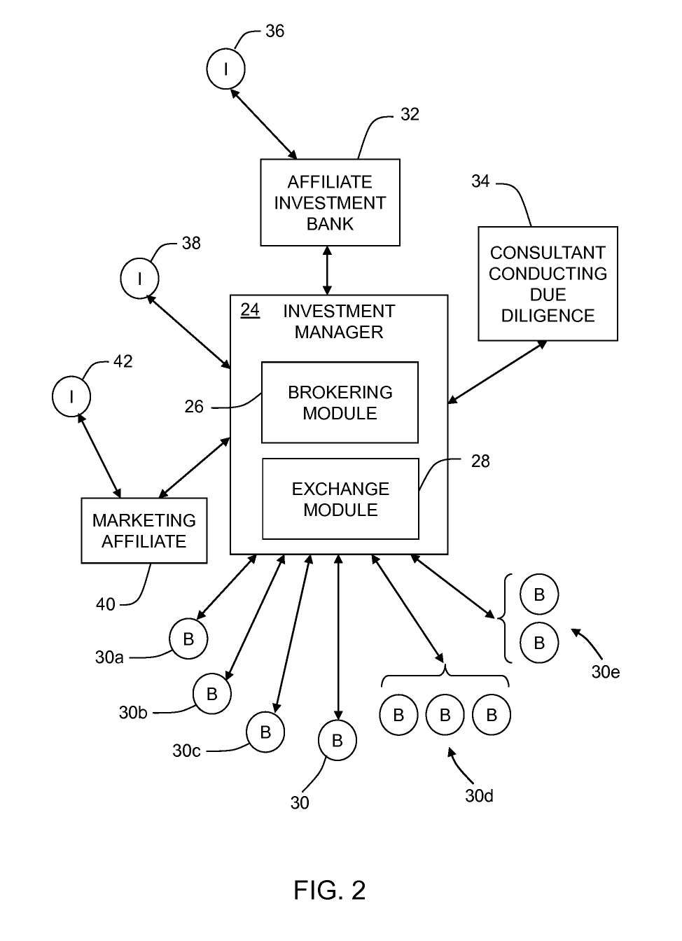

FIG. 2 shows an exemplary illustration of an investment manager (24) which may facilitate the sale of shares from a business (30) to an investor (36, 38, 42). According to some embodiments of the present invention, there may be an investment manager (24) which may include a brokering module (26) and an exchange module (28). According to some embodiments of the present invention, the brokering module (26) may facilitate transactions for businesses offering shares for sale in order to raise money. According to some embodiments of the present invention, the exchange module (28) may facilitate share trading among investors. According to some embodiments of the present invention, the brokering module (26) and the exchange module (28) may be embodied as hardware, software, firmware, or any combination thereof.

Except where explicitly stated otherwise or clear from context, the term “shares” as used in the present invention has a broad meaning that includes both shares issued officially by individual businesses, and “virtual” shares issued by investment managers acting as holding companies of the companies they service. The mechanisms for administering the latter type of share distribution are discussed in more detail below.

According to some embodiments of the present invention, the investment manager (24) may maintain a web site on the Internet. According to some embodiments of the present invention, the web-site may provide information to the public and may receive communications from external parties, such as from businesses interested in offering shares and investors interested in buying shares. According to some embodiments of the present invention, the investment manager (24) may receive communications, for example, via web menus, by filling electronic forms on the web-site, or by electronic mail (“email”). The arrows shown in FIG. 2 represent communications between the different elements of the system. According to some embodiments of the present invention, the communications may be done through the Internet. According to some embodiments of the present invention, communication with the investment manager may be done using social networks such as Facebook, LinkedIn or the like. According to some embodiments of the present invention, communication may be conducted by telephone, facsimile, SMS, or regular postal mail. According to some embodiments of the present invention, any communication means known today or that may be devised in the future may be used to communicate with the investment manager (24).

According to some embodiments of the present invention, a business (30) interested in offering shares to the public may communicate that interest to the investment manager (24). According to some embodiments of the present invention, within the investment manager (24), the communication may be channeled to the brokering module (26). According to some embodiments of the present invention, the investment manager (24) may provide service to the single business (30). According to some embodiments of the present invention, the investment manager (24) may also serve additional individual businesses (30a), (30b), and (30c), and may also serve groups of businesses (30d) and (30e). Groups of businesses (30d) and (30e) may comprise businesses of similar types, such as abstaining from specified business practices that would be undesired by some investors, or of dissimilar types but work together, such as one business supplying parts to another business.

According to some embodiments of the present invention, the brokering module (26) may perform an initial screening of the business (30) to determine whether it would be worthwhile to proceed further in the relationship. According to some embodiments of the present invention, the initial screening may be the beginning of a more thorough due diligence investigation that is typically performed by an investment bank when determining whether to facilitate investment in a business. According to some embodiments of the present invention, the screening process may check various aspects of the business, for instance, it may address the type of incorporation considered by the business and the jurisdiction of the incorporation. The screening may also include inquiring whether parties associated with the business have criminal backgrounds (for example, association with money laundering and participation in fraud). According to some embodiments of the present invention, the brokering module (26) may collect a prospectus from the business (30) and maintain a database of prospectuses for internal use and/or to provide to outsiders as needed in the course of negotiating transactions with investors. According to some embodiments of the present invention, upon reaching a favorable outcome of the initial screening, the brokering module (26) may proceed in conducting a more thorough due diligence before attempting to find investors interested in buying shares of the business (30). As the brokering module (26) accepts more of the burden of the due diligence, the investors are accordingly relieved of a corresponding amount of the burden.

According to some embodiments of the present invention, there may be an affiliate investment bank (32) interested in investing in businesses serviced by the investment manager (24). According to some embodiments of the present invention, the brokering module (26) may function as an intermediary between the business (30) and an affiliate investment bank (32). Without the participation of the brokering module (26), the affiliate investment bank (32) may or may not be interested in investing in the business (30). However, with the involvement of the brokering module (26), the operational costs to the affiliate investment bank (32) may be reduced considerably, and therefore the attractiveness of the business (30) to the affiliate investment bank (32) may be increased. According to some embodiments of the present invention, lesser affluent investors may also participate in share transactions brokered by the brokering module (26), since the lower operational costs to the affiliate investment bank (32) may justify it dealing with smaller investments.

According to some embodiments of the present invention, the brokering module (26) may reduce the operational costs by performing a portion of the due diligence. According to some embodiments of the present invention, the due diligence may be done for determining the likelihood of major problems with the business (30). According to some embodiments of the present invention, the due diligence may determine the business potential of the business (30), for instance, checking the market size, the gross margins, the risks, the technology etc. According to some embodiments of the present invention, the brokering module (26) may perform its portion of the due diligence internally. According to some embodiments of the present invention, the brokering module (26) may outsource the study to an external consultant (34). As the investment manager (24) builds credibility over time with the affiliate investment bank (32), the affiliate investment bank (32) can more and more easily justify dispensing with some of its own due diligence studies.

According to some embodiments of the present invention, with the intervention of the investment manager (24), the affiliate investment bank (32) may seek investors for buying shares offered by the business (30). According to some embodiments of the present invention, the affiliate investment bank (32) may contact an investor (36) to announce the opportunity to buy shares of the business (30). According to some other embodiments of the present invention, the investment manager (24) may seek investors, such as investor 38, directly without using the affiliate investment bank (32). According to some embodiments of the present invention, the investment manager (24) may broker transactions between the business (30) and both investors it has contacted directly, and other investors through an affiliate investment bank (32). According to some embodiments of the present invention, the brokering module may publish on its web site for potential investors, information about the business (30) which may be of interest to the investors. According to some embodiments of the present invention, the published information may include financial statements of the business, biographies of the officers and the directors of the business (30) with information about their compensation, and any lawsuits in which the business (30) may be, or may have been involved with. According to some embodiments of the present invention, the investment manager (24) may also post the prospectus of the business (30) on its web site.

According to some embodiments of the present invention, the investment manager (24) may benefit from the services of a marketing affiliate (40) to attract investors, such as investor 42. According to some embodiments of the present invention, the marketing affiliate (40) may maintain a web site with a banner ad that may link potential investors visiting its web site to the web site of the investment manager (24). According to some embodiments of the present invention, upon an investor (42) visiting the web site of the marketing affiliate (40) and seeing the banner ad, may become interested in learning more about the investment opportunity, and may easily surf to a specially-designed page of the web site maintained by the brokering module (26). According to some embodiments of the present invention, the specially-designed page may have information relating only to the business (30). According to some embodiments of the present invention, the specially-designed page may have information relating to a group of businesses sharing a common attribute, for example, geographic location. According to some embodiments of the present invention, the specially-designed page may have information relating to general information about the services the investment manager (24) provides to investors.

According to some embodiments of the present invention, investors may be attracted using the internet by organic search engine optimization (SEO). According to some embodiments of the present invention, investors may be attracted using the internet by paid search engine marketing. According to some embodiments of the present invention, investors may be attracted by email. According to some embodiments of the present invention, investors may be attracted using social networks (e.g. Facebook, LinkedIn). According to some embodiments of the present invention, the internet may be used to attract investors by means known today or that may be devised in the future.

According to some embodiments of the present invention, the internet tools for attracting investors may be used by the marketing affiliates (40). According to some embodiments of the present invention, the internet tools for attracting investors may be used by the investment manager (24). According to some embodiments of the present invention, the internet tools for attracting investors may be used by the affiliate investment bank (32).

According to some embodiments of the present invention, the exchange module (28) of the investment manager (24) may provide services that may resemble those of a stock exchange. According to some embodiments of the present invention, the business (30) may have the option of having its shares traded among investors, such as investors 36, 38, and 42, as if the shares were traded on an exchange which is managed by the exchange module (28). Such functionality of the exchange module (28) may add an additional option for businesses seeking to issue shares, even if it were not feasible for those businesses to join the known major stock exchanges, such as the New York or Tokyo stock exchanges. According to some embodiments of the present invention, the exchange module (28) may manage and facilitate trading in funds of groups of diversified shares, such as funds of shares of businesses 30d or of businesses 30e. According to some embodiments of the present invention, the investment manager (24) may issue “virtual shares” to investors, such as to the investors 36, 38, and 42, based on the shares entrusted to it from client businesses. According to some embodiments of the present invention, the investment manager (24) can manage the trading of the “virtual shares” between the investors. The term “virtual share” refers to a unit of ownership in a business, as does a conventional share, but a virtual share in this context may be issued by the investment manager (24) instead of directly by the business itself.

According to some embodiments of the present invention, the exchange module (28) may also provide services resembling those of a holding company. These services can be useful, for example, where multiple individual small businesses may not individually attract the attention of investors but collectively and with the aid of the investment manager (24) may become more attractive for trading.

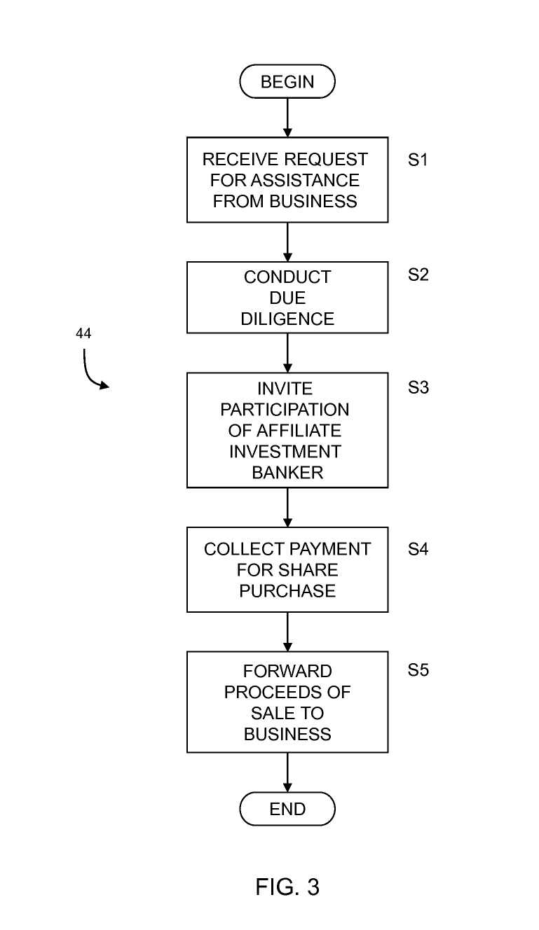

Reference is now made to the flowchart 44 in FIG. 3, which describes some embodiments according to the present invention. According to these embodiments there may be a process that can be performed, for example, by the investment manager (24) of FIG. 2, to facilitate the sale of shares from a business to an investor.

An early step in the process may be receiving a request from a business for assistance in finding buyers of shares in the business (Step SI). According to some embodiments of the present invention, the investment manager (24) may receive a request from a business asking it for assistance in finding buyers for its shares. According to some embodiments of the present invention, the request can be received via the Internet. According to some embodiments of the present invention, the request may be received through a web menu or email or social network (e.g. Facebook, LinkedIn). According to some embodiments of the present invention, the request may be received by telephone, by facsimile, by SMS or by regular postal mail. According to some embodiments of the present invention, the request may be received by any communication means known today or that may be devised in the future. According to some embodiments of the present invention, the request may include a prospectus of the business.

The next step may be conducting due diligence of the business (Step S2). According to some embodiments of the present invention, the investment manager (24) may conduct due diligence of the business. According to some embodiments of the present invention, the due diligence may begin with an initial screening that can be effected by asking questions such as whether parties associated with the business have criminal backgrounds. According to some embodiments of the present invention, on-line social network sites, such as Facebook and LinkedIn may be consulted either for posted information directly of interest or for leads (for example, names of acquaintances) to consult for additional information. According to some embodiments of the present invention, upon having positive results of the initial screening, a more thorough due diligence may be effected to determine whether an investor can be sufficiently assured that the likelihood of major problems with the business is sufficiently low to justify the investment in its shares. According to some embodiments of the present invention, the due diligence may be conducted internally. According to some embodiments of the present invention, the due diligence may be outsourced to an external consultant.

If it is determined that the risks associated with investment in the business are sufficiently low, an affiliate investment bank may be invited to participate in the transaction (Step S3). According to some embodiments of the present invention, upon completion of the due diligence, an affiliate investment bank may be invited to participate in the transaction. Because much of the due diligence has already been conducted, the affiliate investment bank can justify dispensing with a large portion of its own due diligence studies and thus lower its operating costs. Still, the affiliate investment bank retains the freedom to conduct internally an amount of due diligence that it deems appropriate. According to some embodiments of the present invention, upon receiving an invitation to participate, an affiliate investment bank may decide to join the transaction. According to some embodiments of the present invention, upon deciding to join, an affiliate investment bank may conduct its own due diligence. According to some embodiments of the present invention, based on the due diligence results, the affiliate investment bank may decide whether to continue or not with the transaction.

After the affiliate investment bank becomes involved, the party executing the present method, for example, the investment manager (24) in FIG. 2, may wait until the affiliate investment bank finds one or more investors that want to buy shares in the business. According to some embodiments of the present invention, the affiliate investment bank may look for investors who may be interested in buying shares of the business. Optionally, the party executing the present method may additionally search for investors directly or through marketing affiliates. According to some embodiments of the present invention, the investment manager (24) may look for investors either directly or through a marketing affiliate. According to some embodiments of the present invention, the sale of shares may be delayed until a set number of additional affiliate investment banks, for example two more, agree to become involved with the business.

When investors in the business have been located, the next step may be to collect the payment for the share purchase (Step S4). According to some embodiments of the present invention, the investors may transfer the investment amount to the investment manager, and the investment manager may send share certificates to the investors. According to some embodiments of the present invention, a fee may be deducted by the investment manager (24) for the service to the business. According to some other embodiments of the present invention, a fee may be required earlier, or a bill for services may be sent later. According to some embodiments of the present invention, the remaining funds from the payment for the shares may then be forwarded to the business as proceeds of the sale (Step S5). At this point, the process ends.

According to some embodiments of the present invention, the investment manager (24) illustrated in FIG. 2 can include computer readable media/memories for holding instructions that when executed may perform some or all of the steps represented in the flowchart 44 of FIG. 3 and described in the associated text. The computer readable media/memories may be used for holding data structures, tables, records, and/or other data as described above. Computer readable media can include any suitable medium that participates in providing instructions to a processor for execution. Such media may be non-volatile or volatile. The non-volatile media may be magnetic, optical, or, magneto-optical disks. The volatile media may include dynamic memories. Examples of such media described herein also include floppy disks, hard disks, magnetic tape, CD-ROMs, CDRWs, DVDs, RAMs, PROMs, EPROMs, and FLASH-EPROMs.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for facilitating sale of venture related financial instruments, said system comprising:
a communication module adapted to receive over a communication network data representing one or more parameters associated with the venture;
a first module adapted to initiate one or more database queries using search terms derived from the one or more received parameters and further adapted to perform automated business analytics on results from the one or more database queries so as to compile information indicative of an investment potential of the venture;
a second module adapted to accept, execute and/or record financial transactions related to financial instruments of the venture.

2. The system according to claim 1, wherein said communication module or another communication is adapted to communicate some or all of the compiled information to: (1) an affiliate investment bank, and/or to (2) a marketing affiliate.

3. The system according to claim 1, wherein the one or more modules of the system is adapted to generate a web banner associated with one or more financial instruments of the venture.

4. The system according to claim 3, wherein the web banner associated with one or more financial instruments of the venture includes an embedded code identifying the venture and/or a specific financial instrument.

5. The system according to claim 4, wherein the web banner associated with one or more financial instruments of the venture also includes an embedded code identifying an affiliate investment bank and/or a marketing affiliate through which the banner is distributed.

6. The system according to claim 5, wherein the marketing affiliate is a website operator or an online advertising company.

7. The system according to claim 6, wherein one or more modules of said system is adapted to generate a record when a banner distributed through a marketing affiliate initiates a transaction.
